(19) United States
(12) Patent Application Publication
(10) Pub. No.: US 2026/0351636 A1
(43) Pub. Date: Nov. 5, 2026

(54) WORK VEHICLE, CONTROL DEVICE, AND CONTROL METHOD

(71) Applicant: KOMATSU LTD., Tokyo (JP)

(72) Inventors: Yuki Ono, Tokyo (JP); Go Sakuma, Tokyo (JP); Hideyo Ebisuzaki, Tokyo (JP)

(73) Assignee: KOMATSU LTD., Tokyo (JP)

(21) Appl. No.: 19/130,976

(22) PCT Filed: Dec. 22, 2023
(86) PCT No.: PCT/JP2023/046136

§ 371 Date: May 19, 2025

(30) Foreign Application Priority Data
Dec. 22, 2022 (JP) 2022-205764

(51) Int. Cl. H01M 8/04746; B60L 7/10; B60L 58/34; H01M 8/04029; H01M 8/04228; H01M 16/00

(52) U.S. Cl. CPC H01M 8/04768; B60L 7/10; B60L 58/34; H01M 8/04029; H01M 8/04228; H01M 16/006; H01M 2220/20; H01M 2250/20; H01M 2250/402

(57) ABSTRACT

A heater is provided in the same flow path as that of a first heat exchanger that performs heat exchange between a heat medium and the fuel cell. The heater heats the heat medium by the electric energy stored in an electric storage device when the fuel cell is stopped and a temperature of the heat medium is lower than a predetermined threshold.

### TECHNICAL FIELD

The present disclosure relates to a work vehicle, a control device, and a control method.

The present application claims priority based on Japanese Patent Application No. 2022-205764 filed in Japan on Dec. 22, 2022, the content of which is incorporated herein by reference.

### BACKGROUND ART

Since a fuel cell extracts electric power by a chemical reaction, appropriate temperature control is required. There is an operating temperature zone depending on the type of fuel cell. For example, the operating temperature is generally 60 to 80 °C for a polymer electrolyte fuel cell, 800 to 1000 °C for a solid oxide fuel cell, 190 to 200 °C for a phosphoric acid fuel cell, and 600 to 700 °C for a molten carbonate fuel cell.

When the temperature of the fuel cell is lower than the operating temperature zone, energy originally to be converted into electric power is converted into heat, so that power generation efficiency is reduced. Therefore, when the fuel cell is activated under a low temperature environment or when the intermittent operation is performed, a warm-up operation is performed in which the fuel cell is driven while the stoichiometric ratio (stoichiometry) of the oxidant gas (oxygen) is reduced from that during the normal operation. Patent Literature 1 discloses a technology for returning from an operation state with low power generation efficiency to a normal operation state at an early stage.

### CITATION LIST

### Patent Literature

Patent Literature 1: JP 2016-096042 A

### SUMMARY OF INVENTION

### Technical Problem

Since a fuel cell generates heat when being driven, a heat medium such as cooling water is supplied to the fuel cell. On the other hand, in a low temperature environment, the temperature of the heat medium is also low, and the temperature rise of the fuel cell is prevented by the circulation of the cooling water.

An object of the present disclosure is to provide a work vehicle, a control device, and a control method capable of efficiently raising a temperature of a fuel cell in a cold environment.

### Solution to Problem

According to an aspect of the present invention, a work vehicle includes: a fuel cell that generates electric power by reacting hydrogen gas with oxygen in the atmosphere; an electric storage device that stores electric energy; a first heat exchanger that performs heat exchange between a heat medium and the fuel cell; and a heater that heats the heat medium by the electric energy stored in the electric storage device when the fuel cell is stopped and a temperature of the heat medium is lower than a predetermined threshold.

### Advantageous Effects of Invention

According to the above aspect, the work vehicle can efficiently raise a temperature of a fuel cell.

### BRIEF DESCRIPTION OF DRAWINGS

FIG. 1 is a perspective view schematically illustrating a transportation vehicle according to a first embodiment.

FIG. 2 is a diagram illustrating a cooling system for cooling a fuel cell according to the first embodiment.

FIG. 3 is a schematic block diagram illustrating a configuration of an electric system included in the transportation vehicle according to the first embodiment.

FIG. 4 is a schematic block diagram illustrating a configuration of a control device according to the first embodiment.

FIG. 5 is a flowchart illustrating an activation control method of the fuel cell according to the first embodiment.

FIG. 6 is a diagram illustrating the cooling system for cooling the fuel cell according to the first embodiment.

FIG. 7 is a flowchart illustrating the activation control method of the fuel cell according to the first embodiment.

FIG. 8 is a diagram illustrating a configuration of a cooling system according to a modification of a second embodiment.

FIG. 9 is a diagram illustrating a cooling system for cooling a fuel cell according to a third embodiment.

FIG. 10 is a flowchart illustrating an activation control method of the fuel cell according to the third embodiment.

### DESCRIPTION OF EMBODIMENTS

### First Embodiment

### Configuration of Transportation Vehicle 10

Hereinafter, embodiments will be described in detail with reference to the drawings.

A transportation vehicle 10 according to the first embodiment is a dump truck of a rigid frame type that transports crushed stone and the like mined in a mine or the like. The transportation vehicle 10 is driven by a fuel cell 41 using hydrogen gas as a fuel. The transportation vehicle 10 is an example of a work vehicle.

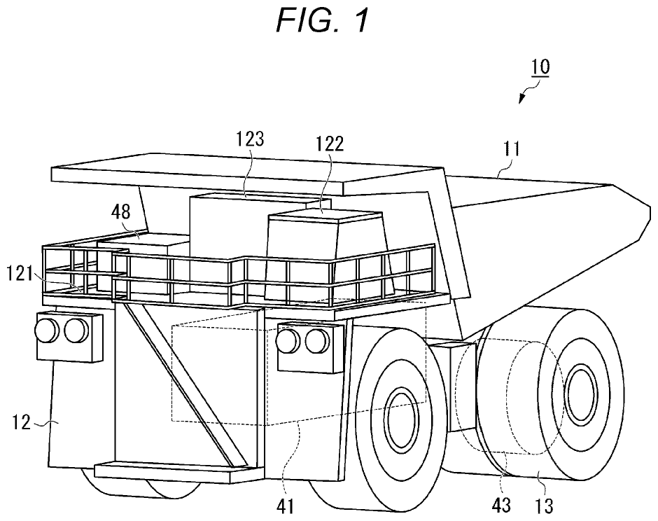

FIG. 1 is a perspective view schematically illustrating the transportation vehicle 10 according to the first embodiment. The transportation vehicle 10 includes a dump body 11, a vehicle body 12, and a traveling device 13.

The dump body 11 is a member on which a load is loaded. At least a part of the dump body 11 is disposed above the vehicle body 12. The dump body 11 performs a dumping operation and a lowering operation. The dump body 11 is adjusted to the dump posture and the loading posture by the dumping operation and the lowering operation. The dump posture refers to a posture in which the dump body 11 is raised. The loading posture refers to a posture in which the dump body 11 is lowered.

The dumping operation refers to an operation of separating the dump body 11 from the vehicle body 12 and inclining the dump body 11 in a dumping direction. The dumping direction is the rear side of the vehicle body 12. In the embodiment, the dumping operation includes raising the front end portion of the dump body 11 and inclining the dump body 11 backward. By the dumping operation, the loading surface of the dump body 11 is inclined downward and backward.

The lowering operation refers to an operation of bringing the dump body 11 close to the vehicle body 12. In the embodiment, the lowering operation includes lowering the front end portion of the dump body 11.

When the soil discharging work is to be performed, a dumping operation is performed to change the posture of the dump body 11 from the loading posture to the dumping posture. In a case where a load is loaded on the dump body 11, the load is discharged backward from the rear end portion of the dump body 11 by the dumping operation. When the loading work is to be performed, the dump body 11 is adjusted to the loading posture.

The vehicle body 12 includes a vehicle body frame (not illustrated). The vehicle body 12 rotatably supports the dump body 11 via a hinge pin provided on the vehicle body frame. The vehicle body 12 is supported by the traveling device 13. A platform 121 is provided on an upper portion of the front wheel of the traveling device 13 in the vehicle body frame. The platform 121 is a flat plate constituting an upper surface of the vehicle body frame. A cab 122, a control cabinet 123, and a retarder grid 44 are provided on the platform 121. The fuel cell 41 is provided on the vehicle body frame.

The control cabinet 123 converts electric power. Specifically, the control cabinet 123 controls power between the fuel cell 41, various electric devices (battery 42, traveling motor 43, and the like), and the retarder grid 44.

The retarder grid 44 is a resistor for absorbing regenerative power generated by braking of the traveling device 13. The retarder grid 44 converts regenerative power into thermal energy.

The traveling device 13 supports the vehicle body 12. The traveling device 13 causes the transportation vehicle 10 to travel. The traveling device 13 moves the transportation vehicle 10 forward or backward. At least a part of the traveling device 13 is disposed below the vehicle body 12. The traveling device 13 includes a pair of front wheels and a pair of rear wheels. The front wheel is a steering wheel, and the rear wheel is a driving wheel.

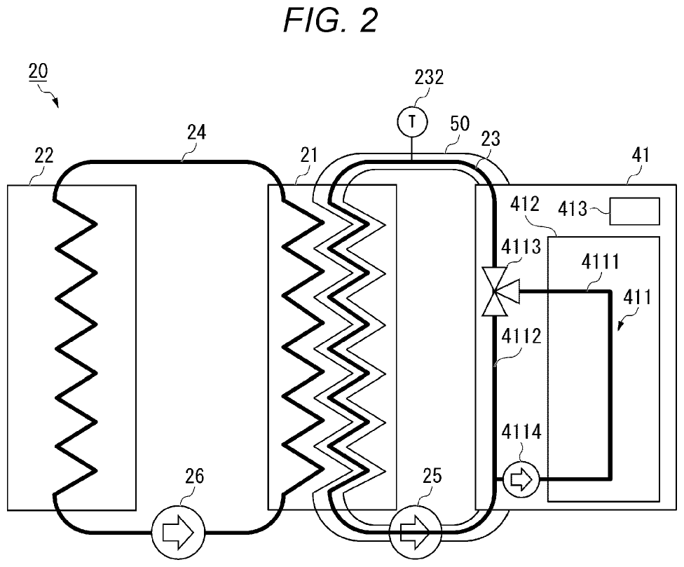

FIG. 2 is a diagram illustrating the cooling system 20 for cooling the fuel cell 41 according to the first embodiment. Since fuel cell 41 generates heat during power generation, it is necessary to perform temperature adjustment in order to maintain an operating temperature zone with high power generation efficiency. The fuel cell 41 includes a cooling mechanism 411 that causes a heat medium such as cooling water to flow inside and causes the heat medium to flow in a main body 412 of the fuel cell 41 to perform heat exchange between the main body 412 and the heat medium. The cooling mechanism 411 includes a main flow path 4111 that passes through the main body 412, a bypass flow path 4112 that does not pass through the main body 412, a switching valve 4113 that switches between the main flow path 4111 and the bypass flow path 4112, and a pump 4114. When the heat medium passes through the main flow path 4111, heat exchange is performed between the main body 412 and the heat medium, and the main body 412 can be cooled. The pump 4114 is provided in the main flow path 4111. The switching valve 4113 and the pump 4114 are controlled by a battery management device 413 provided in the fuel cell 41. The cooling mechanism 411 is an example of a first heat exchanger that exchanges heat between the heat medium and the fuel cell 41.

The cooling system 20 includes an intermediate heat exchanger 21, a radiator 22, a first flow path 23, a second flow path 24, a first pump 25, and a second pump 26.

The intermediate heat exchanger 21 has flow paths on the primary side and the secondary side, respectively, and causes heat exchange between the heat medium flowing to the primary side and the heat medium flowing to the secondary side.

The radiator 22 allows the heat medium to pass therethrough and releases the heat of the heat medium to the outside air.

The first flow path 23 connects the cooling mechanism 411 of fuel cell 41 and the flow path on the secondary side of the intermediate heat exchanger 21 so as to circulate. A heater 50 is provided so as to cover the first flow path 23 and the flow path on the secondary side of the intermediate heat exchanger 21. The heater 50 may be, for example, a ribbon heater. The first flow path 23 is provided with a temperature sensor 232 that measures a temperature of the heat medium flowing through the first flow path 23.

The second flow path 24 connects the flow path on the primary side of the intermediate heat exchanger 21 and the radiator 22 so as to circulate.

The first pump 25 is provided in the first flow path 23 and pumps the heat medium.

The second pump 26 is provided in the second flow path 24 and pumps the heat medium.

The heat of the fuel cell 41 is transferred to the heat medium flowing through the first flow path 23 via the cooling mechanism 411. The heat of the heat medium flowing through the first flow path 23 is transferred to the heat medium flowing through the second flow path 24 via the intermediate heat exchanger 21. The heat of the heat medium flowing through the second flow path 24 is released to the atmosphere via the radiator 22.

### Configuration of Electrical System 40

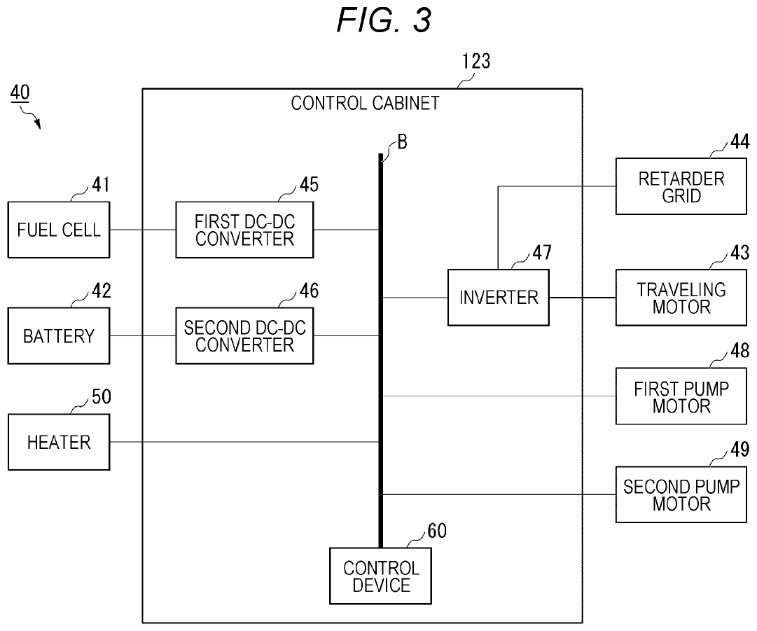

FIG. 3 is a schematic block diagram illustrating a configuration of an electric system 40 included in the transportation vehicle 10 according to the first embodiment. The electric system 40 includes a fuel cell 41, a battery 42, a traveling motor 43, a retarder grid 44, a first DC-DC converter 45, a second DC-DC converter 46, an inverter 47, a first pump motor 48, a second pump motor 49, a heater 50, and a control device 60. The first DC-DC converter 45, the second DC-DC converter 46, the inverter 47, and the control device 60 are provided in the control cabinet 123.

The fuel cell 41 generates electric power by reacting hydrogen gas supplied from a hydrogen tank (not illustrated) with oxygen contained in outside air. The first DC-DC converter 45 supplies the DC power generated by the fuel cell 41 to the bus B.

The battery 42 stores electric power generated in the fuel cell 41. The battery 42 is an example of an electric storage device. The battery 42 stores regenerative power generated in the traveling motor 43. The battery 42 outputs the stored electric power. The second DC-DC converter 46 supplies the power charged in the battery 42 to the bus B. The second DC-DC converter 46 charges the battery 42 by adjusting the voltage of the DC power flowing through the bus B and supplying the voltage to the battery 42. That is, the second DC-DC converter 46 is an example of a charging device. The battery 42 includes a battery management system (BMS) (not illustrated) that monitors the state of the battery 42. The BMS measures the charging rate of the battery 42 and outputs measurement data to the control device 60.

The traveling motor 43 is an electric motor (three-phase AC electric motor) that drives the traveling device 13. The inverter 47 converts DC power flowing through the bus B into three-phase AC power and supplies the three-phase AC power to the traveling motor 43. The inverter 47 converts regenerative power generated in the traveling motor 43 by braking of the traveling device 13 into DC power and supplies the DC power to the bus B.

The first pump motor 48 drives the first pump 25 by DC power flowing through the bus B.

The second pump motor 49 drives the second pump 26 by the DC power flowing through the bus B.

The heater 50 generates heat by DC power flowing through the bus B.

The control device 60 controls the first DC-DC converter 45, the second DC-DC converter 46, the inverter 47, the first pump motor 48, the second pump motor 49, and the heater 50 on the basis of measurement data received from various sensors including the temperature sensor 232.

### Configuration of Control Device 60

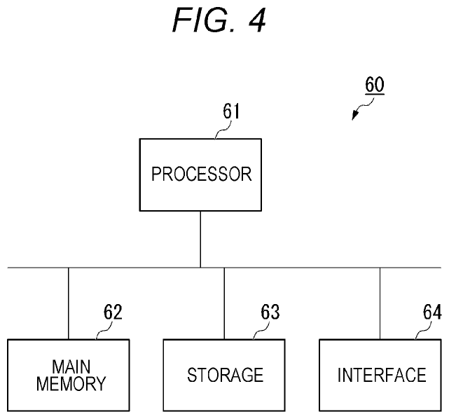

FIG. 4 is a schematic block diagram illustrating a configuration of the control device 60 according to the first embodiment.

The control device 60 is a computer including a processor 61, a main memory 62, a storage 63, and an interface 64.

The processor 61 reads the computer program from the storage 63, develops the computer program in the main memory 62, and executes the processing according to the program. Examples of the processor 61 include a central processing unit (CPU), a graphic processing unit (GPU), and a micro processor.

The program is for achieving some of functions to be exerted by the control device 60. For example, the program may exert a function by a combination with another program already stored in the storage or a combination with another program mounted on another device. In another embodiment, the control device 60 may include a custom large scale integrated circuit (LSI) such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions implemented by the processor 61 may be implemented by the integrated circuit. Such an integrated circuit is also included in an example of the processor.

Examples of the storage 63 include a magnetic disk, a magneto-optical disk, an optical disk, a semiconductor memory, and the like. The storage 63 may be an internal medium directly connected to the bus or an external medium connected to the control device 60 via the interface 64 or a communication line. Furthermore, in a case where this program is distributed to the control device 60 via a communication line, the control device 60 that has received the distribution may expand the program in the main memory 62 and execute the above processing. In at least one embodiment, the storage 63 is a non-transitory tangible storage medium.

The program may be for achieving a part of the functions described above. The program may be a program that achieves the above-described functions in combination with another program already stored in the storage 63, that is, a so-called difference file (difference program).

### Activation Control by Control Device 60

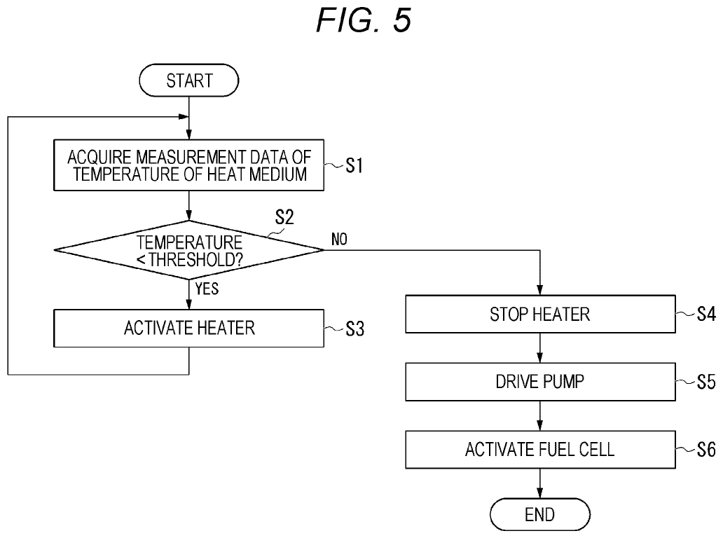

FIG. 5 is a flowchart illustrating an activation control method of the fuel cell according to the first embodiment.

The activation control of the fuel cell 41 according to the first embodiment is executed at the time of key-on of the transportation vehicle 10 and at the time of intermittent operation scheduled by the control device 60. The activation of the fuel cell 41 refers to supplying hydrogen and air to the fuel cell 41 in a non-operating state to operate the fuel cell 41.

When starting the activation control of the fuel cell 41, the control device 60 acquires the measurement data from the temperature sensor 232 (step S1). The control device 60 determines whether the value of the acquired measurement data is lower than a predetermined threshold (step S2). For example, the threshold is set to a value close to the lower limit value of the operating temperature zone of the fuel cell 41.

If the value of the acquired measurement data is lower than the predetermined threshold (step S2: YES), the control device 60 activates the heater 50 to heat the heat medium in the first flow path 23 (step S3). Electric power for operating the heater 50 is supplied from the battery 42 via the second DC-DC converter 46. At this time, the control device 60 does not drive the first pump 25. This is to prevent a load from being applied to the switching valve 4113, the pump 4114, the main body 412, and the like of the fuel cell 41 by forcibly circulating the heat medium from the outside while the fuel cell 41 is stopped. The switching valve 4113 and the pump 4114 are controlled by the battery management device 413, and the control device 60 cannot normally control the switching valve 4113 and the pump 4114 from the outside.

The flow then returns to step S1 to continue monitoring the temperature of the first flow path 23.

If the value of the acquired measurement data is equal to or greater than the predetermined threshold (step S2: NO), the control device 60 stops the heater 50 (step S4). When the heater 50 is not activated in step S3, the control device 60 maintains the state in which the heater 50 is stopped. Next, the first pump motor 48 and the second pump motor 49 are driven (step S5). As a result, the first pump 25 and the second pump 26 are driven, and the heat medium in the first flow path 23 and the second flow path 24 circulates. Then, the control device 60 activates the fuel cell 41 by driving a pump and an air compressor of a hydrogen tank (not illustrated) (step S6), and ends the processing.

### Operation and Effect

As described above, the transportation vehicle 10 according to the first embodiment includes the heater 50 that heats the heat medium by the electric energy stored in the battery 42 when the temperature of the heat medium is lower than the predetermined threshold. Since the electric energy used for the operation of the heater 50 is supplied not from the fuel cell 41 but from the battery 42, the fuel cell 41 is not used while the power generation efficiency of the fuel cell 41 raising the temperature of the heat medium is poor. As a result, the transportation vehicle 10 can activate the fuel cell 41 in a state with high power generation efficiency even in a low temperature environment at the time of starting the fuel cell 41. When the fuel cell 41 operates, the fuel cell 41 generates heat, so that the heater 50 does not need to heat the heat medium. Therefore, the heater 50 according to the first embodiment heats the heat medium when the fuel cell 41 is stopped and the temperature of the heat medium is lower than a predetermined threshold. In another embodiment, the heat medium may be heated when the temperature of the heat medium is lower than a predetermined threshold regardless of whether the fuel cell 41 is stopped.

The cooling system 20 according to the first embodiment includes the intermediate heat exchanger 21, but may not include the intermediate heat exchanger 21 in other embodiments. In this case, the heater 50 is provided so as to cover the radiator 22 and the piping connecting the fuel cell 41 and the radiator 22.

The heater 50 according to the first embodiment is provided so as to cover a range in which the fuel cell 41 and the intermediate heat exchanger 21 are connected to each other in the intermediate heat exchanger 21 and the first flow path 23. Accordingly, the temperature of the entire heat medium held in the first flow path 23 can be raised without applying a load to the fuel cell 41 by driving the first pump 25.

### Second Embodiment

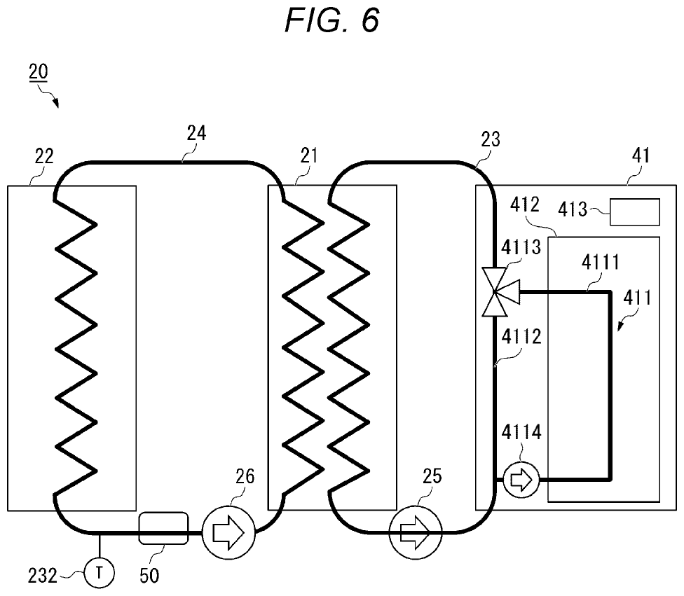

A transportation vehicle 10 according to a second embodiment includes a cooling system 20 having a configuration different from that of the first embodiment. FIG. 6 is a diagram illustrating the cooling system 20 for cooling the fuel cell 41 according to the first embodiment.

As in the first embodiment, the cooling system 20 according to the second embodiment includes an intermediate heat exchanger 21, a radiator 22, a first flow path 23, a second flow path 24, a first pump 25, and a second pump 26. On the other hand, a heater 50 and a temperature sensor 232 according to the second embodiment are provided in the second flow path 24. The heater 50 is provided in the second flow path 24 or a part of the radiator 22. The temperature sensor 232 is provided on the upstream side of the heater 50.

### Activation Control by Control Device 60

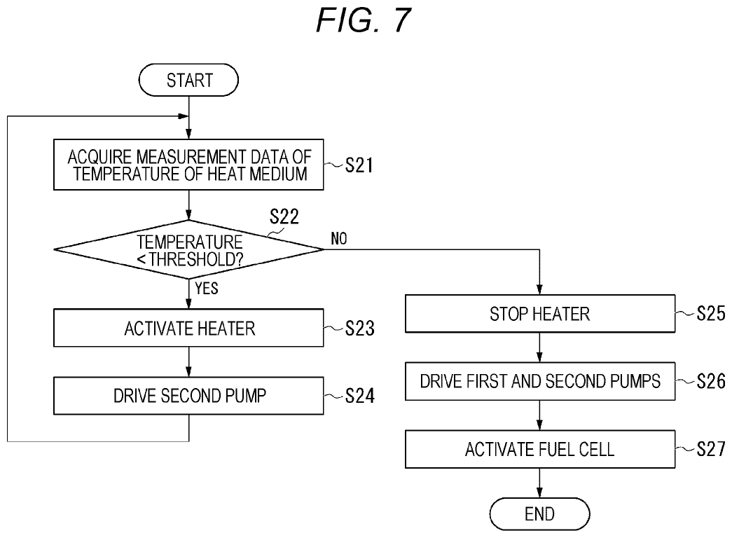

FIG. 7 is a flowchart illustrating the activation control method of the fuel cell according to the first embodiment. When starting the activation control of the fuel cell 41, the control device 60 according to the second embodiment acquires the measurement data from the temperature sensor 232 (step S21). The control device 60 determines whether the value of the acquired measurement data is lower than a predetermined threshold (step S22). If the value of the acquired measurement data is lower than the predetermined threshold (step S22: YES), the control device 60 activates the heater 50 to heat the heat medium in the second flow path 24 (step S23). Electric power for operating the heater 50 is supplied from the battery 42 via the second DC-DC converter 46. The control device 60 drives the second pump motor 49 (step S24). As a result, the heat medium in the second flow path 24 circulates by the second pump 26, and the entire heat medium in the second flow path 24 is heated by the heater 50. On the other hand, the control device 60 does not drive the first pump 25. The flow then returns to step S21 to continue monitoring the temperature of the first flow path 23.

If the value of the acquired measurement data is equal to or greater than the predetermined threshold (step S22: NO), the control device 60 stops the heater 50 (step S25). When the heater 50 is not activated in step S23, the control device 60 maintains the state in which the heater 50 is stopped. Next, the first pump motor 48 and the second pump motor 49 are driven (step S26). As a result, the first pump 25 and the second pump 26 are driven, and the heat medium in the first flow path 23 and the second flow path 24 circulates. When the second pump motor 49 is already driven in step S24, the control device 60 maintains the state in which the second pump motor 49 is driven. Then, the control device 60 activates the fuel cell 41 by driving a pump and an air compressor of a hydrogen tank (not illustrated) (step S27), and ends the processing.

### Operation and Effect

As described above, the heater 50 according to the second embodiment is provided in the second flow path 24 and heats the heat medium by the electric energy stored in the battery 42 when the temperature of the heat medium is lower than the predetermined threshold. At this time, the second pump 26 is driven to pump the heat medium in the second flow path 24. As a result, even when the heater 50 is provided only in the radiator 22, the intermediate heat exchanger 21, or a part of the second flow path 24, the temperature of the entire heat medium flowing through the second flow path 24 can be raised. Since the control device 60 drives the second pump 26 but does not drive the first pump 25, no load is applied to the fuel cell 41.

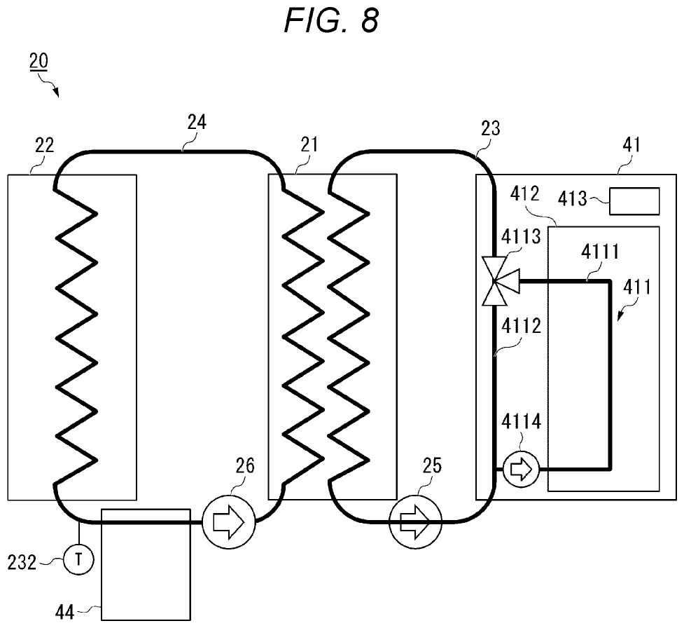

FIG. 8 is a diagram illustrating a configuration of a cooling system 20 according to a modification of the second embodiment. In another embodiment, a heat exchanger that performs heat exchange between the retarder grid 44 and the second flow path 24 may be provided in the second flow path 24 instead of the heater 50. In this case, the control device 60 instructs the inverter 47 to supply electric power to the retarder grid 44 instead of activating the heater 50 in step S23. As a result, the heat generated by the retarder grid 44 can be supplied to the second flow path 24 to raise the temperature of the heat medium in the second flow path 24. In another embodiment, the flow path for recovering heat of the retarder grid 44 and the second flow path 24 may be provided separately, and heat exchange may be performed in the radiator 22.

### Third Embodiment

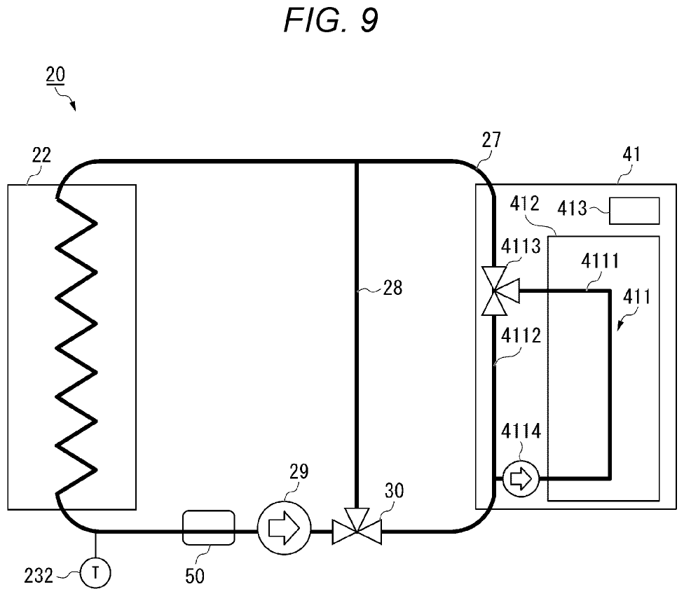

A transportation vehicle 10 according to a third embodiment includes a cooling system 20 having a configuration different from that of the first and second embodiments. FIG. 9 is a diagram illustrating the cooling system 20 for cooling the fuel cell 41 according to the first embodiment.

The cooling system 20 according to the third embodiment includes a radiator 22, a circulation flow path 27, a shortcut flow path 28, a pump 29, and a switching valve 30. That is, the cooling system 20 according to the third embodiment does not include the intermediate heat exchanger 21.

The circulation flow path 27 connects a cooling mechanism 411 of the fuel cell 41 and the radiator 22 so as to circulate.

The shortcut flow path 28 connects the cooling mechanism 411 of the fuel cell 41 and the radiator 22 in the circulation flow path 27.

The pump 29 is provided between the radiator 22 and the shortcut flow path 28 in the circulation flow path 27. The pump 29 pumps the heat medium in the circulation flow path 27.

The switching valve 30 is provided at a connection portion between the circulation flow path 27 and the shortcut flow path 28. The switching valve 30 switches between allowing the heat medium flowing from the radiator 22 to pass through the cooling mechanism 411 of the fuel cell 41 and allowing the heat medium to pass through the shortcut flow path 28. When the heat medium passes through the shortcut flow path 28, the heat medium circulates to the radiator 22 without passing through the cooling mechanism 411.

In the circulation flow path 27, a heater 50 is provided between the shortcut flow path 28 and the radiator 22. A temperature sensor 232 that measures the temperature of the heat medium flowing through the circulation flow path 27 is provided on the upstream side of the heater 50 in the circulation flow path 27.

### Activation Control by Control Device 60

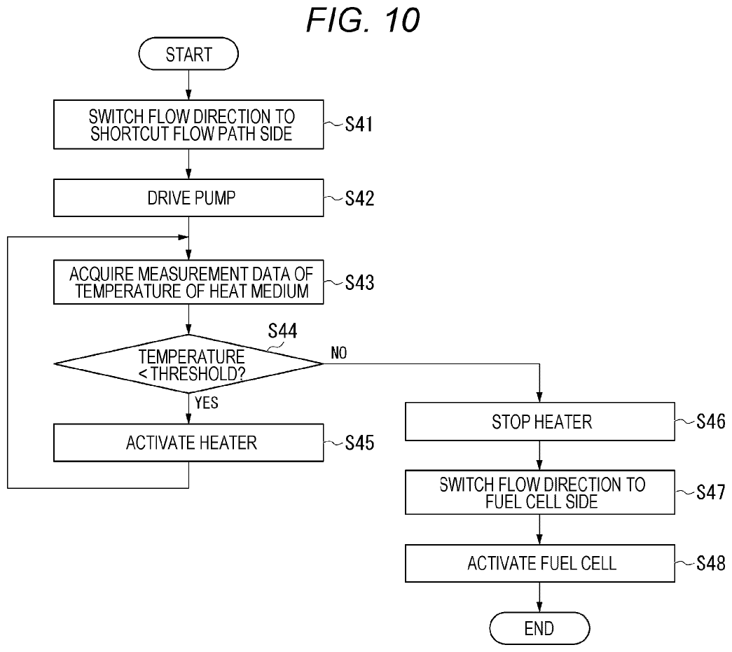

FIG. 10 is a flowchart illustrating an activation control method of the fuel cell according to the third embodiment. When the control device 60 according to the third embodiment starts the activation control of the fuel cell 41, the control device 60 outputs an instruction signal for switching the flow direction to the shortcut flow path 28 side to the switching valve 30 (step S41). Next, the control device 60 drives the pump 29 (step S42). As a result, the heat medium in the circulation flow path 27 circulates between the radiator 22 and the shortcut flow path 28.

Next, measurement data is acquired from the temperature sensor 232 (step S43). The control device 60 determines whether the value of the measurement data acquired in step S43 is lower than a predetermined threshold (step S44). If the value of the acquired measurement data is lower than the predetermined threshold (step S44: YES), the control device 60 activates the heater 50 to heat the heat medium in the second flow path 24 (step S45). Electric power for operating the heater 50 is supplied from the battery 42 via the second DC-DC converter 46. The heat medium in the circulation flow path 27 is heated by the heater 50. On the other hand, the heat medium is not supplied to the cooling mechanism 411 of the fuel cell 41 by switching valve 30. The flow then returns to step S43 to continue monitoring the temperature of the first flow path 23.

If the value of the acquired measurement data is equal to or greater than the predetermined threshold (step S44: NO), the control device 60 stops the heater 50 (step S46). When the heater 50 is not activated in step S45, the control device 60 maintains the state in which the heater 50 is stopped. Next, the control device 60 outputs an instruction signal for switching the flow direction to the fuel cell 41 side to the switching valve 30 (step S47). As a result, the heat medium flows through the fuel cell 41. Then, the control device 60 activates the fuel cell 41 by driving a pump and an air compressor of a hydrogen tank (not illustrated) (step S48), and ends the processing.

### Operation and Effect

As described above, the heater 50 according to the third embodiment is provided between the shortcut flow path 28 and the radiator 22 in the circulation flow path 27. At this time, while the temperature of the heat medium is lower than the threshold, the heat medium is not supplied to the fuel cell 41 through the shortcut flow path 28 by the switching valve 30. As a result, the control device 60 can raise the temperature of the heat medium without applying a load to the fuel cell 41.

### Other Embodiments

Although the embodiment has been described above in detail with reference to the drawings, the specific configuration is not limited to the above-described configuration, and various design changes and the like can be made. That is, in another embodiment, the order of the above-described processing may be appropriately changed. In addition, some processes may be executed in parallel.

The control device 60 according to the above-described embodiment may be configured by a single computer, or the configuration of the control device 60 may be divided into a plurality of computers and the plurality of computers may function as the control device 60 in cooperation with each other. At this time, some computers constituting the control device 60 may be mounted inside the work machine, and other computers may be provided outside the work machine.

### INDUSTRIAL APPLICABILITY

According to the above aspect, the work vehicle can efficiently raise a temperature of a fuel cell.

### REFERENCE SIGNS LIST

10 Transportation vehicle
11 Dump body
12 Vehicle body
121 Platform
122 Cab
123 Control cabinet
13 Traveling device
20 Cooling system
21 Intermediate heat exchanger
22 Radiator
23 First flow path
232 Temperature sensor
24 Second flow path
25 First pump
26 Second pump
40 Electrical system
41 Fuel cell
411 Cooling mechanism
42 Battery
43 Traveling motor
44 Retarder grid
45 First DC-DC converter
46 Second DC-DC converter
47 Inverter
48 First pump motor
49 Second pump motor
50 Heater
60 Control device
61 Processor
62 Main memory
63 Storage
64 Interface
27 Circulation flow path
29 Pump
28 Shortcut flow path
30 Switching valve

1. A work vehicle comprising:
a fuel cell that generates electric power by reacting hydrogen gas with oxygen in the atmosphere;
an electric storage device that stores electric energy;
a first heat exchanger that is provided in the fuel cell and performs heat exchange between a heat medium and the fuel cell; and
a heater that heats the heat medium by the electric energy stored in the electric storage device when a temperature of the heat medium is lower than a predetermined threshold.

2. The work vehicle according to claim 1, comprising
a second heat exchanger for cooling the heat medium; and
a circulation flow path that circulates the heat medium between the first heat exchanger and the second heat exchanger, wherein
the heater is provided in at least a part of the circulation flow path.

3. The work vehicle according to claim 2, comprising:
a shortcut flow path connecting the first heat exchanger and the second heat exchanger in the circulation flow path;
a pump that is provided in the circulation flow path between the second heat exchanger and the shortcut flow path and pumps the heat medium; and
a valve that can switch between allowing the heat medium flowing from the second heat exchanger to flow through the first heat exchanger and allowing the heat medium to flow through the shortcut flow path, the valve allowing the heat medium to pass through the shortcut flow path when the fuel cell is stopped and a temperature of the heat medium is lower than a predetermined threshold, and allowing the heat medium to pass through the first heat exchanger when the fuel cell is driven, wherein
the heater is provided between the second heat exchanger and the shortcut flow path in the circulation flow path.

4. The work vehicle according to claim 1, comprising:
a second heat exchanger;
a third heat exchanger;
a first circulation flow path that circulates the heat medium between the first heat exchanger and the second heat exchanger; and
a second circulation flow path that circulates the heat medium between the second heat exchanger and the third heat exchanger, wherein
the heater is provided in at least a part of the second circulation flow path.

5. The work vehicle according to claim 1, wherein
the heater heats the heat medium by the electric energy stored in the electric storage device when the fuel cell is stopped and a temperature of the heat medium is lower than a predetermined threshold, and does not heat the heat medium when the fuel cell is not stopped.

6. The work vehicle according to claim 1, comprising:
a traveling motor that is an electric motor; and
a traveling device driven by the traveling motor, wherein
the heater is a retarder brake that converts regenerative power of the traveling motor into thermal energy.

7. A control device for a work vehicle comprising:
a fuel cell that generates electric power by reacting hydrogen gas with oxygen in the atmosphere;
an electric storage device that stores electric energy;
a first heat exchanger that performs heat exchange between a heat medium and the fuel cell; and
a heater that heats the heat medium by electric energy, wherein
the control device heats the heater by the electric energy stored in the electric storage device when a temperature of the heat medium is lower than a predetermined threshold.

8. A control method for a work vehicle including:
a fuel cell that generates electric power by reacting hydrogen gas with oxygen in the atmosphere;
an electric storage device that stores electric energy;
a first heat exchanger that performs heat exchange between a heat medium and the fuel cell; and
a heater that heats the heat medium by the electric energy, the method comprising
a step of heating the heater by the electric energy stored in the electric storage device when a temperature of the heat medium is lower than a predetermined threshold.

9. The work vehicle according to claim 2, wherein
the heater heats the heat medium by the electric energy stored in the electric storage device when the fuel cell is stopped and a temperature of the heat medium is lower than a predetermined threshold, and does not heat the heat medium when the fuel cell is not stopped.

10. The work vehicle according to claim 3, wherein
the heater heats the heat medium by the electric energy stored in the electric storage device when the fuel cell is stopped and a temperature of the heat medium is lower than a predetermined threshold, and does not heat the heat medium when the fuel cell is not stopped.

11. The work vehicle according to claim 4, wherein
the heater heats the heat medium by the electric energy stored in the electric storage device when the fuel cell is stopped and a temperature of the heat medium is lower than a predetermined threshold, and does not heat the heat medium when the fuel cell is not stopped.

12. The work vehicle according to claim 2, comprising:
a traveling motor that is an electric motor; and
a traveling device driven by the traveling motor, wherein
the heater is a retarder brake that converts regenerative power of the traveling motor into thermal energy.

13. The work vehicle according to claim 3, comprising:
a traveling motor that is an electric motor; and
a traveling device driven by the traveling motor, wherein
the heater is a retarder brake that converts regenerative power of the traveling motor into thermal energy.

14. The work vehicle according to claim 4, comprising:
a traveling motor that is an electric motor; and
a traveling device driven by the traveling motor, wherein
the heater is a retarder brake that converts regenerative power of the traveling motor into thermal energy.
